(19) United States
(12) Patent Application Publication
(10) Pub. No.: US 2018/0308144 A1
(43) Pub. Date: Oct. 25, 2018

(54) APPLICATION BASED ONLINE MARKETPLACE

(71) Applicant: Joseph E Traba, III, Miami, FL (US)

(72) Inventor: Joseph E Traba, III, Miami, FL (US)

(21) Appl. No.: 15/497,105

(22) Filed: Apr. 25, 2017

(51) Int. Cl. G06Q 30/06; G06Q 30/02

(52) U.S. Cl. CPC G06Q 30/0625; G06Q 30/0239; G06Q 30/0209; G06Q 30/0277; G06Q 30/0207

(57) ABSTRACT

A method, data processing system and computer program product for an application-based online marketplace for video games and other digital objects. In an embodiment of the invention, a method for an application-based online marketplace for video games can include downloading an application-based online marketplace application, initiating the application-based online marketplace application, receiving data for a user account, determining a value of store credit of the received digital object and displaying the determined value of store credit.

### BACKGROUND OF THE INVENTION

### Field of the Invention

The present invention relates to online portals and more particularly to an application based online marketplace for used digital objects.

### Description of the Related Art

By gaining access rights from owners, users may quickly and easily access a variety of digital objects, also known as content. These digital objects include images, electronic books “e-books,” audio recordings, video recordings, computer applications, and other forms of information transferable over a communication network such as the internet.

As use of digital objects increases, users may wish to transfer the digital objects to other users. These transfers may include a sale, a rental, a gift, a loan, a trade, etc. However, several problems manifest when transferring a digital object. While a physical object such as a copy of a paperback book only exists in one place at a time, easy and inexpensive copies of a digital object without loss of fidelity are possible. Thus, easy copying and repeated sale of the same digital object is possible, potentially eliminating scarcity of the digital object. Because of this, many owners implement digital rights management to prevent such impermissible transfers. Furthermore, the digital object as originally transferred to the initial purchaser may have license restrictions or other limitations on permissible use or further transfer. For example, a license to use a free download of a popular song may expire after a few days.

A secondary market that allows users to effectively and permissibly transfer “used” digital objects to an online store is therefore desired. A “used” digital object is one to which a user has legitimately obtained access or ownership rights (hereinafter “access rights”), and to which the user may permissibly transfer to an online store.

In such a marketplace, a key aspect will include how to value the “used” digital object that a user seeks to trade-in.

### BRIEF SUMMARY OF THE INVENTION

Embodiments of the present invention address deficiencies of the art in respect to a marketplace for used digital objects and provide a novel and non-obvious method, system and computer program product for providing a marketplace for used digital objects. In an embodiment of the invention, a method for an application-based online marketplace for video games can include downloading an application-based online marketplace application, initiating the application-based online marketplace application, receiving data for a user account, determining a value of store credit of the received digital object and displaying the determined value of store credit.

In one aspect of the embodiment, the method can include offering a shopping opportunity to a user to apply a store credit. The method further can include providing access to a library of digital object titles.

In another embodiment of the invention, a cloud computing data processing system can be provided. The system can include a marketplace server that can be a hardware appliance with at least one processor and memory configured for communicative coupling to different user systems over computer communications network. The marketplace server can be coupled to different platform storage, each platform storage supporting value record storage in a cloud-computing environment. Of note, a value calculation module can execute in the memory of the marketplace server by at least one processor of the marketplace server. A computing data processing system including a platform server executing on a hardware appliance and accessible over a communication network, where the platform server includes at least one processor and memory and configured for communicative coupling to different users, where the at least one processor is configured to provide a sign up user interface, receive user data, create a user account, the user account having various security features, receive a digital object for store credit, determine a value of store credit of the received digital object, and display the determined value of store credit.

In another embodiment of the invention, a computer program product for providing a marketplace for used digital objects can be provided. The computer program product can include program code for downloading an application-based online marketplace application, initiating the application-based online marketplace application, receiving data for a user account, determining a value of store credit of the received digital object and displaying the determined value of store credit. In one aspect of the embodiment, the computer program product can further include program code for offering a shopping opportunity to a user to apply a store credit. The computer program product further can include program code for providing access to a library of digital object titles.

Additional aspects of the invention will be set forth in part in the description which follows, and in part will be understandable from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for providing a marketplace for used digital objects;

FIG. 2 is a schematic illustration of a cloud computing data processing system configured for providing a marketplace for used digital objects; and,

FIG. 3 is a flow chart illustrating a process for providing a marketplace for used digital objects.

### DETAILED DESCRIPTION OF THE INVENTION

Embodiments of the present invention address deficiencies of the art in respect to a marketplace for used digital objects and provide a novel and non-obvious method, system and computer program product for providing a marketplace for used digital objects. A method, data processing system and computer program product for an application-based online marketplace for video games and other digital objects. In an embodiment of the invention, a method for an application-based online marketplace for video games can include downloading an application-based online marketplace application, initiating the application-based online marketplace application, receiving data for a user account, determining a value of store credit of the received digital object and displaying the determined value of store credit. In an aspect of the embodiment, the method can further include offering a shopping opportunity to a user to apply a store credit. In a further aspect of the embodiment, the method can still further include providing access to a library of digital object titles.

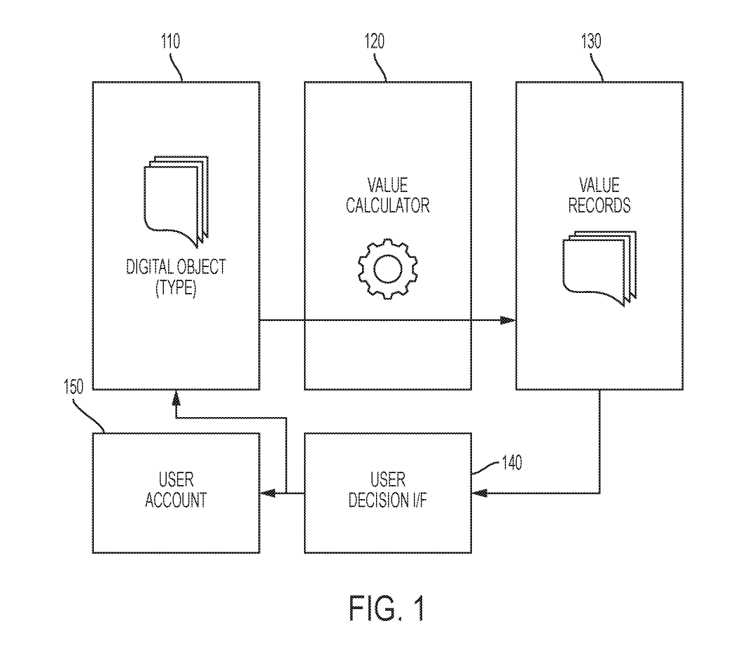

In further illustration, FIG. 1 is a pictorial illustration of a process for providing a marketplace platform for used digital objects. As shown in FIG. 1, different digital objects 110 of different digital object types, such as different games, can have their values calculated by a value calculator 120 to create digital object value records 130. The value records 130 can be provided or presented to a user via a user decision interface 140. A user can review the value record generated or assigned to a digital object in a decision making step to determine if the user accepts the calculated value record 130. If the user accepts the calculated value record 130 then that calculated value can be credited to the user's account 150.

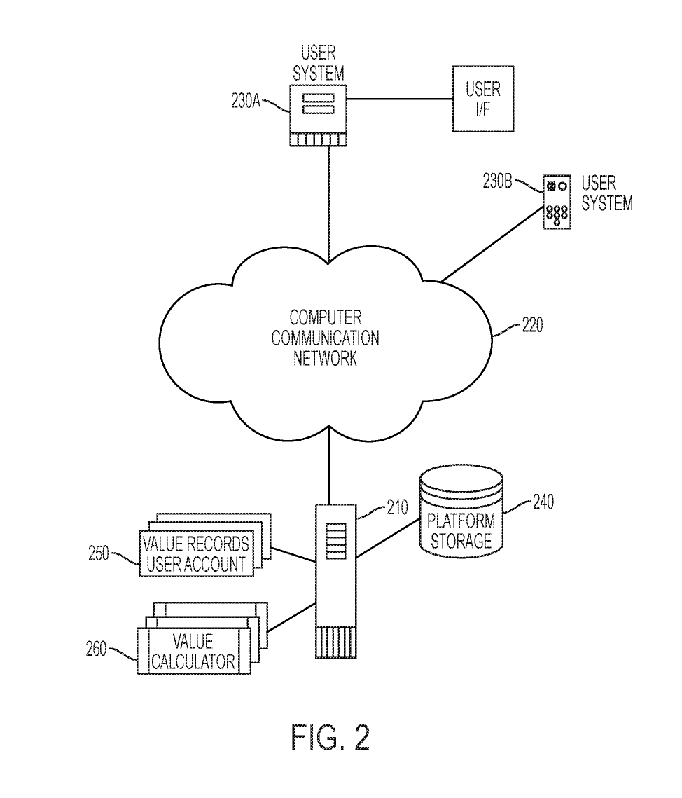

The process described in connection with FIG. 1 can be implemented in a computing data processing system. In further illustration, FIG. 2 schematically shows a computing data processing system configured for providing a marketplace platform for used digital objects. The system includes a marketplace server 210 which can be a hardware appliance with at least one processor and memory configured for communicative coupling to different user systems 230A, 230B, 230N over computer communications network 220. The marketplace server 210 can be coupled to different platform storage 240, each supporting value record storage 250 in a cloud-computing environment. Of note, a digital object value calculator module 260 can execute in the memory of the marketplace server 210 by at least one processor of the marketplace server 210. The digital object value calculator module 260 can be a computer program that includes program code configured to calculate a value of a digital object provided by a user system 230A, 230B, 230N based on the weighting of numerous factors related to the provided digital object. For example, various input factors are used to determine the digital object value, including but not limited to relative market price, year made, version, players, cooperation, game development, popularity of the game, number of other players to trade in the game, critic rating and the like. In embodiments, the marketplace server can be a software engine configured to execute in the memory of a general computer by at least one processor of the general computer.

In some embodiments, a percentage figure may be used, such as, for every game a user trades in that user receives ten percent (10%) of what the game costs brand new. For example, assume that a brand new game costs sixty dollars, so if a ten percent (10%) credit is given to the user/owner, then the user will receive six dollars for the used game, the value of which will be added to that user's store credit. Next, the owner is allowed to apply six dollars to a game that owner wants to purchase. Once this store credit is applied, the owner then reduces the price of the game that owner wants to buy by six dollars, then pays the difference for it with that owner's card on file. With the applied credit, the average player would be paying fifty-four dollars for a game considering the user trades in one game. If the user trades in more than one used game with a limit of three per every 3-4 months, the value given for the user's total games could equal up to twenty-four dollars in store credit, which means that user could reduce the price of brand new games by almost half. Naturally, this is one example of how a value can be assigned to a used digital object, it is in no way meant to be limiting or restrictive as to the invention.

In some embodiments, trade-in value promotions, membership deals and similar factors can be included into the digital object value calculation. In such embodiments, the factors can be assigned a weigh based on the promotional or membership characteristics that the deployer of the application based online marketplace desires. For example, promotional deals for the users during certain time frames, such as during holidays could be used.

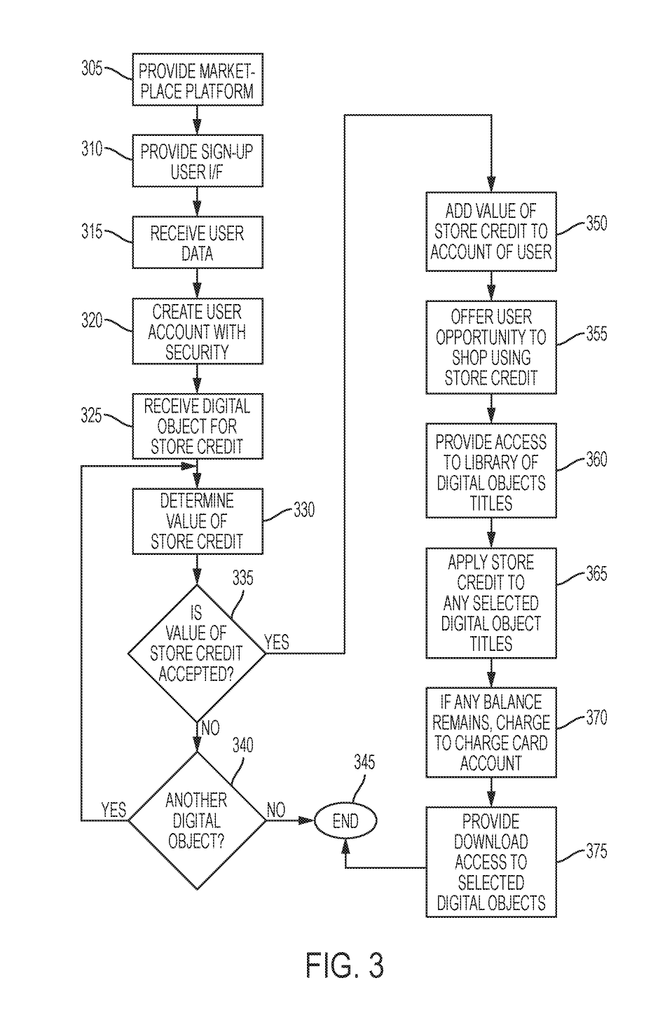

FIG. 3 is a flow chart illustrating a process for providing a marketplace for used digital objects in a cloud-computing environment. Beginning in block 305, a marketplace platform is provided. The marketplace platform is meant to be implemented on numerous platforms including but not limited to xbox live, playstation network, a PC and the like. In block 310, a sign-up user interface is provided. In block 315, the system can receive user input data and in block 320, and a user account with appropriate security features can be created. For example, the user will be prompted with a signup screen requiring the user to create an account username and password, to enter an email address, and to enter a credit card. In block 325, a user can upload a digital object, (e.g., games) for which the user wishes to obtain store credit. In block 330, a digital object value calculator module will determine the value of the uploaded digital object. The digital object value calculator will use various input factors to determine the game value, including but not limited to relative market price, year made, version, number of players, cooperation, game development, replayability and the like. In decision block 335, the value of the store credit is presented to the user, who can then accept or reject the calculated store credit of the digital object.

If the value of the calculated store credit of the digital object is accepted by the user, in block 350, then the value of the calculated store credit of the digital object is added to the account of the user. On the other hand, if the value of the calculated store credit of the digital object is refused by the user, in decision block 340, the user is prompted for another digital object. If the user uploads a new digital object, then in block 330, the digital object value calculator module will determine the value of the new uploaded digital object and present that new value to the user.

In block 355, the user is offered the opportunity to shop using the accepted store credit. In block 360, the user is provided with access to the library of digital object titles stored in the system and is able to select any of the digital object titles in the library. In block 365, any store credit in the user's account can be applied to any of the selected digital object titles. In block 370, if there is a balance remaining for the selected digital object titles, it may be charged to a credit card related to the user's account. In block 375, the selected digital object titles can be downloaded by the user to the user's electronic device. Thereafter, the process can repeat though decision block 325 with the continued submission of digital objects for store credit. With each transaction on the application-based online marketplace for video games and other digital objects, a transaction fee is charged to the user's account.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for providing a marketplace for used digital objects in a cloud computing environment comprising:
providing a sign up user interface;
receiving user data;
creating a user account, the user account having various security features;
receiving a digital object for store credit;
determining a value of store credit of the received digital object; and,
displaying the determined value of store credit.

2. The method of claim 1, further comprising:
offering a shopping opportunity to a user to apply a store credit.

3. The method of claim 1, further comprising:
providing access to a library of digital object titles.

4. The method of claim 1, further comprising:
applying a determined value of store credit.

5. The method of claim 1, wherein determining a value of store credit of the received digital object comprises:
applying a digital object value calculator module to a received digital object.

6. The method of claim 5, wherein determining a value of store credit of the received digital object comprises:
receiving a set of characteristics of the received digital object; and
entering the set of characteristics of the received digital object into the digital object value calculator module to generate a value of store credit.

7. The method of claim 5, wherein determining a value of store credit of the received digital object comprises:
assigning a ten percent credit value for the value of store credit.

8. The method of claim 6, wherein the set of characteristics comprises:
a relative market price, a year made and a version.

9. A computing data processing system comprising:
a platform server executing on a hardware appliance and accessible over a communication network,
the platform server including at least one processor and memory and configured for communicative coupling to different users;
the processor configured to:
provide a sign up user interface;
receive user data;
create a user account, the user account having various security features;
receive a digital object for store credit;
determine a value of store credit of the received digital object; and,
display the determined value of store credit.

10. The system of claim 9, wherein the processor is further configured to offer a shopping opportunity to a user to apply a store credit.

11. The system of claim 9, wherein the processor is further configured to provide access to a library of digital object titles.

12. A computer program product for providing a marketplace for used digital objects in a cloud computing environment, the computer program product comprising:
a computer readable storage medium having computer readable program code embodied therewith, the computer readable program code comprising:
computer readable program code for providing a sign up user interface;
computer readable program code for receiving user data;
computer readable program code for creating a user account, the user account having various security features;
computer readable program code for receiving a digital object for store credit;
computer readable program code for determining a value of store credit of the received digital object; and,
computer readable program code for displaying the determined value of store credit.

13. The computer program product of claim 12, wherein the computer readable program code for determining a value of store credit of the received digital object, comprises:
computer readable program code for extracting information about the received digital object and applying a weighted value to the extracted information.

14. The computer program product of claim 12, wherein the computer readable program code further comprising computer readable program code for offering a shopping opportunity to a user to apply a store credit.

15. The computer program product of claim 12, wherein the computer readable program code further comprising computer readable program code for providing access to a library of digital object titles.

16. The computer program product of claim 12, wherein the computer readable program code further comprising computer readable program code for applying a determined value of store credit.

17. The computer program product of claim 12, wherein the computer readable program code further comprising computer readable program code for applying a digital object value calculator module to a received digital object.

18. The computer program product of claim 12, wherein the computer readable program code further comprising
computer readable program code for receiving a set of characteristics of the received digital object; and
computer readable program code for entering the set of characteristics of the received digital object into the digital object value calculator module to generate a value of store credit.

19. The computer program product of claim 18 wherein the set of characteristics comprises:
a relative market price, a year made and a version.
